(19) United States
(12) Patent Application Publication
(10) Pub. No.: US 2026/0219910 A1
(43) Pub. Date: Jul. 30, 2026

(54) HARDWARE ACCELERATOR EMULATION

(71) Applicant: Lemon Inc., Grand Cayman (KY)

(72) Inventors: Ping ZHOU, Los Angeles, CA (US); Quanbo HU, Beijing (CN); Hui ZHANG, Los Angeles, CA (US); Bo LI, Beijing (CN); Shan XIAO, Beijing (CN); Fei LIU, Los Angeles, CA (US)

(21) Appl. No.: 19/039,421

(22) Filed: Jan. 28, 2025

(51) Int. Cl. G06F 9/455

(52) U.S. Cl. CPC G06F 9/45558; G06F 2009/45575

(57) ABSTRACT

The present disclosure involves methods, apparatus, and systems for identifying a query to perform in an emulated data analytics environment; parsing, by a first virtual machine (VM) executing a first operating system (OS), two subsets of operations from the plurality of operations; sending, by the first VM, the second subset of operations to a custom interface; receiving, by a second VM executing a second OS and from the custom interface, the second subset of operations; executing, by the second VM, the second subset of operations using an emulated hardware accelerator executing on the second VM, wherein executing the second subset of operations comprises performing a read operation of a memory using a standard interface; and returning, by the second VM, results associated with the second subset of operations to the first VM using the custom interface.

### TECHNICAL FIELD

The present disclosure generally relates to emulating a hardware accelerator using virtual machines.

### BACKGROUND

Hardware accelerators are specialized hardware components designed to speed up specific computations, often those that are computationally intensive or require high throughput. By offloading tasks from general-purpose CPUs to dedicated hardware, accelerators achieve substantial performance gains and reduced energy consumption. Common examples of hardware accelerators can include Graphics Processing Units (GPUs); Field-Programmable Gate Arrays (FPGAs), highly customizable chips that can be reconfigured to implement specific algorithms; and Application-Specific Integrated Circuits (ASICs), and chips designed for a specific task, which can deliver maximum performance but require significant upfront investment and design time.

### SUMMARY

The present disclosure relates to a method, system, and computer-readable storage media for emulating a hardware accelerator using virtual machines. The solution can include identifying a query to perform in an emulated data analytics environment, the query comprising a plurality of operations; parsing, by a first virtual machine (VM) executing a first operating system (OS), two subsets of operations from the plurality of operations, wherein a first subset of operations comprises operations to be performed within the first OS and wherein a second subset of operations comprises operations to be performed on a hardware accelerator; sending, by the first VM, the second subset of operations to a custom interface; receiving, by a second VM executing a second OS and from the custom interface, the second subset of operations; executing, by the second VM, the second subset of operations using an emulated hardware accelerator executing on the second VM, wherein executing the second subset of operations comprises performing a read operation of a memory using a standard interface; and returning, by the second VM, results associated with the second subset of operations to the first VM using the custom interface.

Implementations can optionally include one or more of the following features.

In some instances, the custom interface is a software agent configured to receive requests as a non-volatile memory express (NVMe) device and relay the requests to the second VM using an inter-VM channel.

In some instances, the inter-VM channel is a UNIX socket.

In some instances, the second OS is configured to emulate firmware executing on a hardware accelerator.

In some instances, the memory is a shared memory, and the solution includes: executing, by the first VM, the first subset of operations, wherein executing the first subset of operations comprises performing a read operation of the memory, using the custom interface.

In some instances, prior to identifying the query, the first VM writes a data file to the shared memory, and wherein executing the second subset of operations comprises performing a read operation of the data file.

In some instances, the standard interface is an NVMe host interface.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A illustrates a block diagram of an example system that uses a hardware accelerator to perform data analytics.

FIG. 1B illustrates a block diagram of an example system that uses a hardware accelerator to perform data analytics in an alternate layout.

FIG. 2 illustrates a block diagram of an example system for emulating a hardware accelerator.

FIG. 3 is a flowchart illustrating an example process for processing a query using an emulated hardware accelerator.

FIG. 4 illustrates a schematic diagram of an example computing system.

Like reference numbers and designations in the various drawings indicate like elements.

### DETAILED DESCRIPTION

This specification relates to methods, apparatuses, and systems for testing hardware and firmware by emulating the hardware and firmware in virtual machines. Modern data analytics pipelines often use hardware accelerators to improve overall query speed. A hardware accelerator is a specialized piece of hardware designed to perform specific computational tasks much faster and more efficiently than a general-purpose CPU. These accelerators are optimized for particular workloads, such as graphics processing, artificial intelligence, or scientific simulations. By offloading certain demanding tasks to dedicated hardware, accelerators can significantly improve computational performance, reduce energy consumption, and enable new levels of computational power. They are increasingly essential in fields like machine learning, high-performance computing, and data-intensive applications. Hardware accelerators often run with a custom operating system (OS) or firmware and require specialized communications protocols or commands. Therefore, when designing and developing a new hardware accelerator, associated software must be designed, developed, and validated simultaneously. Often the hardware cannot operate without the firmware/software, and the software cannot be tested or validated without the software. An error in design on either side can cause costly delays in production or development and can often only be first identified late in the development cycle.

This disclosure resolves some of these problems by creating a computing environment that can emulate a host and associated hardware accelerator. Enabling validation of software/firmware without having a finalized hardware design for the accelerator. Many hardware accelerators act as both hardware devices (e.g., when receiving communication from the host) and hardware hosts (e.g., when performing read operations of data). Because of this “two-headed” nature, it is difficult to emulate a hardware accelerator as a stand-alone device. However, the entire environment (e.g., host, accelerator, and memory) can be emulated using a pair of virtual machines communicating with customized interfaces that are configured to simulate hardware accelerator communication protocols.

This solution is advantageous in that it enables testing and validation of accelerator firmware, and the communication path between the host and the accelerator, without requiring a completed hardware accelerator. Additionally, hardware accelerator emulation can enable identification of weaknesses or flaws in hardware design before the design is complete, providing enhanced flexibility during the development process.

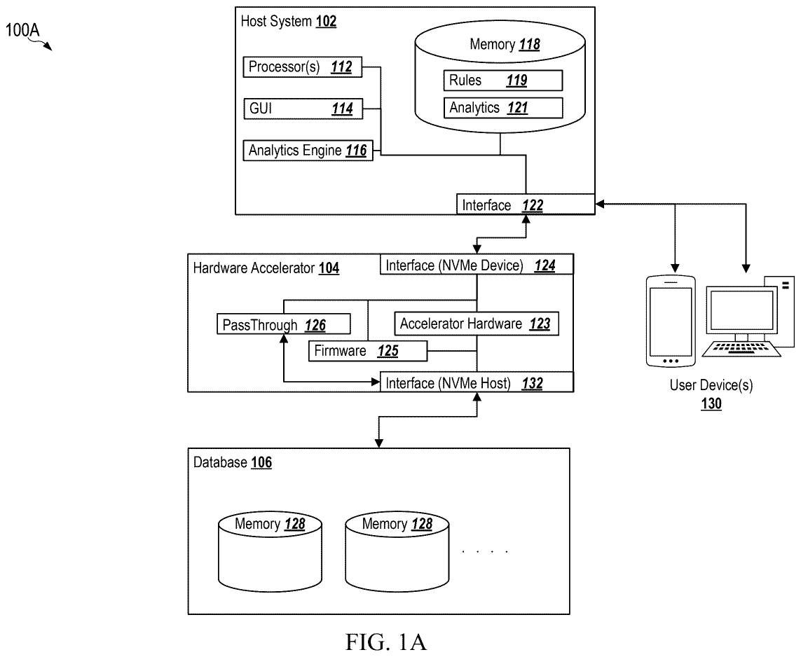

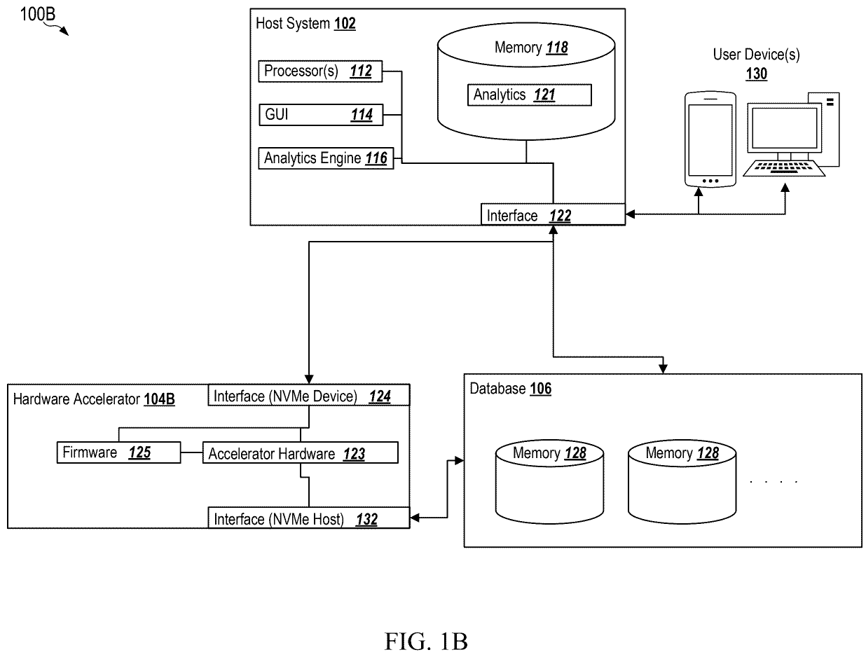

FIG. 1A illustrates a block diagram of an example system 100A that uses a hardware accelerator to perform data analytics. The system 100A includes a host system 102, a hardware accelerator 104, and a database 106. The host system 104 can be configured to perform analytics on the database 106 using the hardware accelerator 104 to offload certain computations.

For example, a user device 130 might request a keyword search of the database 106 with certain filters applied. Or a query might be provided that requests a comparison between two sets of data tables. The analytics engine 116 of the host system 102 can review the query and generate a pipeline of multiple operations. For example, the query “SELECT a,b FROM table WHERE a=2 and b>3” can be divided into a TableScan operator (including decompressing and decoding), a filter operator, and a projection operator. The analytics engine 116 can then evaluate for each operation whether to perform the operation locally using processor(s) 112, or to offload the operation to the hardware accelerator 104. In some implementations, the analytics engine 116 selects operations to be offloaded using a set of predefined rules 119 stored in a local host memory 118.

Memory 118 can represent a single memory or multiple memories. The memory 118 can include any memory or database module and can take the form of volatile or non-volatile memory including, without limitation, magnetic media, optical media, random access memory (RAM), read-only memory (ROM), removable media, or any other suitable local or remote memory component. The memory 118 can store various objects or data, including analytics 121, rules 119, user and/or account information, administrative settings, password information, caches, applications, backup data, repositories storing business and/or dynamic information, and any other appropriate information associated with the host system 102, including any parameters, variables, algorithms, instructions, rules, constraints, or references thereto. Additionally, the memory 118 can store any other appropriate data, firmware logs and policies, firewall policies, a security or access log, print or other reporting files, as well as others. While illustrated within the system 100, memory 118 or any portion thereof, including some or all of the particular illustrated components, can be located remote from the system 100 in some instances, including as a cloud application or repository or as a separate cloud application or repository when the system 100 itself is a cloud-based system.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the CDN estimation system 102. Specifically, the processor 112 executes the algorithms and operations described in the illustrated figures, as well as the various software modules and functionality, including the functionality for sending communications to and receiving transmissions from host system 102, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the host system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

GUI 114 of the host system 102 interfaces with at least a portion of the system 100 for any suitable purpose, including generating a visual representation of any particular application or results and/or the content associated with any components of the user devices 130. In particular, the GUI 114 can be used to present results of a query or allow the user to input queries to the host system 102, as well as to otherwise interact and present information associated with one or more applications. GUI 114 can also be used to view and interact with various web pages, applications, and web services located local or external to the host system 102. Generally, the GUI 114 provides the user with an efficient and user-friendly presentation of data provided by or communicated within the system. The GUI 114 can include a plurality of customizable frames or views having interactive fields, pull-down lists, and buttons operated by the user. In general, the GUI 114 is often configurable, supports a combination of tables and graphs (bar, line, pie, status dials, etc.), and is able to build real time portals, application windows, and presentations. Therefore, the GUI 114 contemplates any suitable graphical user interface, such as a combination of a generic web browser, a web-enable application, intelligent engine, and command line interface (CLI) that processes information in the platform and efficiently presents the results to the user visually.

User devices 130 are computing devices or computers used by one or more users and developer of the software application to interact within system 100, respectively. For example, the user devices 130 can interact with the host system 102 to review analytic results from the database 106 in a graphical user interface (GUI) 114. In some cases, system 100 describes an enterprise computing environment, where the user devices 130 can analyze database objects (e.g., analytics 121, memory(s) 128, etc.). As used in the present disclosure, the term “computer” or “computing devices” is intended to encompass any suitable processing device. For example, the user devices 130 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. Similarly, the user devices 130 can be any system that can request data and/or interact with the host system 102. The user devices 130, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 130 can include one or more specific applications executing on the user devices 130, or the user devices 130 can include one or more web browsers or web applications that can interact with particular applications executing remotely from the user devices 130.

Interface 122 can be used by the host system 102 to communicate with other systems in a distributed environment—including within the system 100 and outside of the system 100 (e.g., hardware accelerator 104, user devices 130, and other systems communicably coupled to the illustrated host system 102. Generally, the interface 122 includes logic encoded in software and/or hardware in a suitable combination and operable to communicate with the system 100 and other components. More specifically, the interface 122 can include software supporting one or more communication protocols associated with communications such that or interface 122's hardware is operable to communicate physical signals within and outside of the illustrated system 100. Still further, the interface 122 can allow the host system 102 to perform the operations described herein.

Once the analytics engine 116 has parsed the query, operations that are to be performed by the local processor(s) 112 can be executed. These operations can include data reads from database 106. In FIG. 1A, these data reads occur via the hardware accelerator 104, which interfaces with the host system 102 like a non-volatile Memory Express (NVMe) Device 124. The queries are then sent to the database 106 and memories 128 can be read using the accelerator 104's pass through functionality 126, which passes read requests from the NVMe device interface 124 to the database 106, and back to processors 112.

The hardware accelerator 104 includes two interfaces, the NVMe device interface 124 and the NVMe host interface 132. NVMe device interface 124 can be a high-performance communication protocol specifically designed for accessing non-volatile storage media, such as solid-state drives (SSDs), connected using a PCI Express (PCIe) bus. NVMe leverages the low latency and high bandwidth capabilities of PCIe to significantly improve data transfer speeds and reduce storage bottlenecks compared to older interfaces such as serial advanced technology attachment (SATA) interfaces. It achieves this by employing parallel command queues, optimized data paths, and efficient power management mechanisms, resulting in faster boot times, quicker file transfers, and enhanced overall system responsiveness. When communicating with the host system 102, the hardware accelerator 104 appears as a device, receiving either read requests for the processors 112, which are sent through passthrough 126, or offload commands that specify operations to be performed by the accelerator hardware 123.

The NVMe host interface 132 can be used by the hardware accelerator 104 to read data, for operations performed by either accelerator hardware 123 or the processors 112. The NVMe host interface 132 can act as a bridge, translating host commands (from the accelerator hardware 123, firmware 125, or a combination thereof) and data into the specific format required by the database 106, and vice versa. In some implementations, the NVMe Host interface enables command submission and completion queuing, interrupt handling, power management, and error handling.

Database 106 can be any suitable database, which stores data in one or more memories 128. In some implementations, the database 106 compresses stored data. The database 106 can communicate with other components (e.g., hardware accelerator 104 or host system 102) using a PCIe connection and act as an NVMe device or set of NVMe devices.

FIG. 1B illustrates a block diagram of an example system 100B that uses a hardware accelerator to perform data analytics in an alternate layout. A majority of the components in FIG. 1B are identical to the example of FIG. 1A, however the host system 102 in system 100B is directly connected to the database 106, removing the need for a passthrough system in the hardware accelerator 104B for operations that do not need acceleration.

Both the system 100A of FIGS. 1A and 100B of FIG. 1B are suitable topologies for hardware accelerated database or information management.

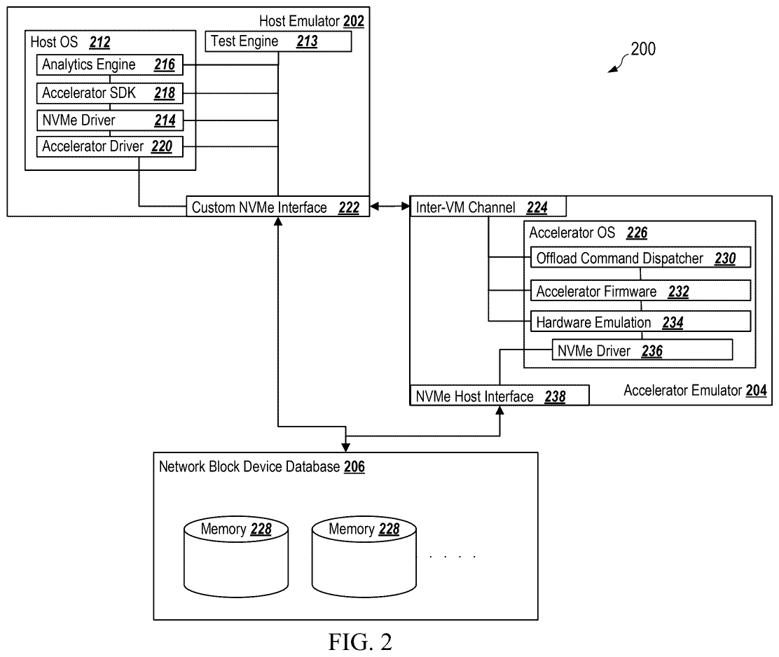

FIG. 2 illustrates a block diagram of an example system 200 for emulating a hardware accelerator. System 200 can represent a virtual emulation of the host system, hardware accelerator, database, and communications between these components. System 200 includes a host emulator 202, an accelerator emulator 204, and a network block device (NBD) database 206. In some implementations, the host emulator 202 and the accelerator emulator 204 are separate virtual machines (VMs) that share the NBD database 206 as a common memory.

In some implementations, each VM is instantiated with an open-source emulator such as QEMU, VirtualBox, RedHat Virtualization, or other emulator system. These emulators allow the use of a VM to simulate hardware components such as ASICs, GPUs, as well as their interfaces, firmware, and operating systems.

The host emulator 202 can run a host OS 212 which can be, for example, a Linux kernel, Windows, MacOS, or other operating system. An analytics engine 216 can be installed and can operate similarly to analytics engine 116 as described above with respect to FIG. 1. The accelerator software development kit (SDK) 218 can be loaded into the host OS 212. The accelerator SDK converts parsed offload commands from the analytics engine 216 into a format suitable for consumption by the accelerator. The accelerator driver 220 can be software that acts as an intermediary between the host operating system 212 and a hardware accelerator, or in the example system 200 the accelerator emulator 204. It provides the software interface that allows the operating system 212 and other programs (e.g., analytics engine 216 or accelerator SDK 218) to access and control the hardware accelerator's functions.

The NVMe Driver 214 can be similar to the accelerator driver 220 except that it uses standard protocols to read and communicate with the NBD database 206.

The custom NVMe interface 222 can be a software interface that parses requests received from either the NVMe driver 214, or the accelerator driver 220 and sends them to the appropriate recipient. The custom NVMe interface 222, when receiving requests from the NVMe Driver 214, can pass the requests to the NBD database 206 as if it were an NVMe host. The NBD database 206 will return the requested information to the custom NVMe interface 222 which can return it to the eNVMe Driver 214 and/or the analytics engine 216.

If a request is received from the accelerator driver 220, the custom NVMe Interface 222 can pass that request to the Accelerator Emulator 204 using an inter-VM channel 224. The Inter VM channel 224 can be any suitable communication channel that allows the host emulator 202 to send custom accelerator commands to the accelerator emulator 204 while the accelerator emulator 204 simulates active as an NVMe device from the perspective of the host emulator 202. The inter VM channel 224 can be, for example, a UNIX socket, QEMU ivshmem (inter-VM, shared memory), an NVIDIA Inter_VM channel, or other function.

A test engine 213 can enable the testing of the analytics engine 216, accelerator SDK 218, accelerator driver 220, as well as components of accelerator emulator 204 such as the hardware emulation 234 and accelerator firmware 232. The test engine 213 can pre-load data into the NBD database 206, which can be a shared database between the host emulator 202 and the accelerator emulator 204. Therefore, this pre-loaded data is accessible by both VMs (host emulator 202 and accelerator emulator 204). The test engine 213 can then send queries or requests to the analytics engine 216, for analysis of the pre-loaded data.

Requests or offload commands from the accelerator driver 220 are received by the accelerator OS 226 executing on the accelerator emulator 204. An offload command dispatcher 230 distributes the offload commands via accelerator firmware 232 to emulated accelerator hardware 234.

The emulated hardware 234 can then begin processing the offload commands, including reading from the NBD database 206. In order to read from the NBD database 206, the accelerator OS 226 (e.g., which can be a Linux OS or other OS) can send read commands through NVMe driver 236, which can be similar to NVMe Driver 214 and can send commands to the NBD database 206 using an NVMe host interface 238. By separating the accelerator emulator 204 into a distinct VM, it can act as an NVMe device from the perspective of the host emulator 202 using the custom NVMe interface 222, and inter-VM channel 224, while acting as an NVMe host from the perspective of the NBD database 206 using the NVMe host interface 238, and NVMe driver 236.

System 200 can be used to test and validate the accelerator SDK 218, accelerator driver 220, analytics engine 216, and accelerator OS 226, which includes the offload command dispatcher 230, accelerator firmware 232, and NVMe driver 238.

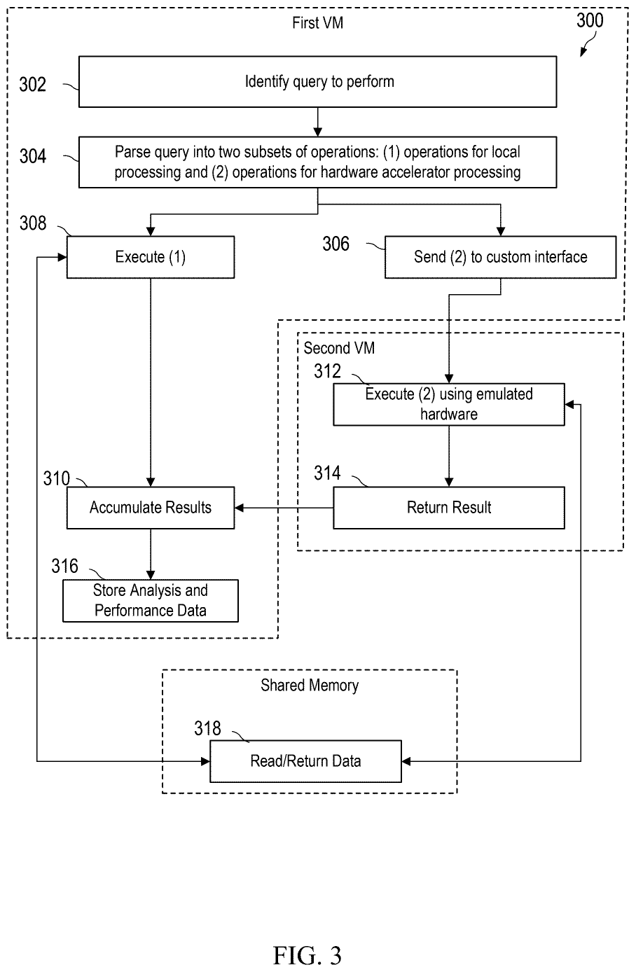

FIG. 3 is a flowchart illustrating an example process for processing a query using an emulated hardware accelerator. The operations of process 300 can be performed, for example, based on the techniques described with respect to FIGS. 1A, 1B, and 2, or in another manner.

The operations shown in process 300 may not be exhaustive and other operations can be performed as well before, after, or in between any of the illustrated operations. Further, some of the operations may be performed simultaneously, or in a different order than shown in FIG. 3.

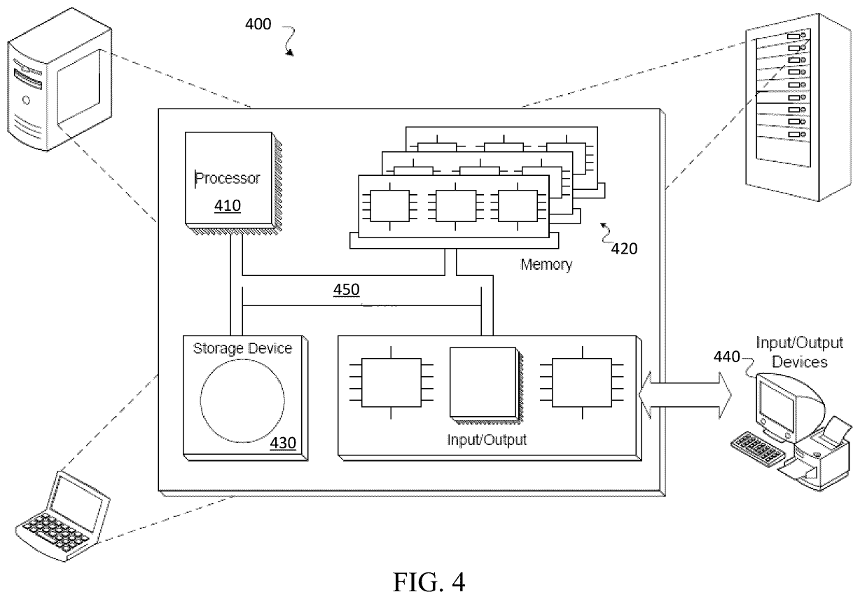

In some implementations, some of the operations may be performed by a computer, or multiple computers. The one or more computers the process 300 will be described as being performed by a system of, located in one or more locations, and programmed appropriately in accordance with this specification. For example, one or more of a computing system 400 of FIG. 4, appropriately programmed, can perform the process 300. As another example, one or more computers in the example system 200 (e.g., the hardware accelerator emulator 204), when appropriately programmed, can perform the process 300.

At 302, a query to perform on a dataset is identified. The query can be a certain data analysis, or search, among other things. The query can include multiple filters, or requests, which will be performed in multiple steps or operations in order to satisfy the query.

At 304, the query is parsed into operations required to satisfy. This can be, for example, hundreds or thousands of distinct computing operations. The operations can be categorized based on their type or complexity, and certain operations can be selected to be offloaded to a hardware accelerator. These offloaded operations can form a second subset, where a first subset of operations is the remaining operations that are to be performed locally by the host machine. For example, operations that are too complex for the accelerator to execute. Or operations that handle unsupported data types, can be performed locally, while other operations are offloaded to the accelerator.

At 306, the second subset of operations is sent to a custom interface, where offload commands are generated and sent to the second VM that emulates the hardware accelerator. By using a custom interface, specific communications protocols can be tested. This enables validation of the accelerator driver in the first VM, as well as the accelerator firmware which is emulated in the second VM. In some implementations, the custom interface is a software agent that parses commands from the first VM as either NVMe host commands, or offload commands to be sent to the second VM.

At 308, the first set of operations is executed locally in the first VM. This can include querying and reading from a shared memory, which will return the requested data (318). In some implementations, the read request is made from the first VM using an NVMe host protocol.

At 310, the first VM accumulates results from the first subset of operations and the second subset of operations when completed by the second VM emulating a hardware accelerator.

At 312, the second set of operations are received from the first VM using an inter-VM channel. In this manner, the second VM can simulate communicating as an NVMe device to the first VM, then running emulated firmware and emulated accelerator hardware, process the second subset of operations. Processing the second subset of operations can include performing read requests to the shared memory (318). In some implementations, these read requests are made using an NVMe host protocol. In this manner, the second VM acts as both an NVMe device (e.g., when communicating with the first VM), and an NVMe host (e.g., when communicating with the shared memory).

At 314, the results of the second subset of operations are returned to the first VM. In some implementations this is done using the inter-VM channel as an NVMe device.

Returning to 310, the first VM accumulates the results from the first subset and the second subset of operations into a query return representing an analysis of the data according to the original query.

At 316, The analysis and metadata are stored for review. In some implementations, the metadata includes errors, performance data, parsing information, and other details regarding the performance of the communications channels (e.g., inter-VM channel, NVMe host and device protocols, etc.) as well as the operating systems executing on the first VM, second VM, and firmware or emulated firmware and emulated hardware operating on the second VM.

FIG. 4 illustrates a schematic diagram of an example computing system 400. The system 400 can be used for the operations described in association with the implementations described herein. For example, the system 400 may be included in computing devices of the one or more online components and/or the one or more offline components. The system 400 includes a processor 410, a memory 420, a storage device 430, and an input/output device 440, which are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

What is claimed is:

1. A computer-implemented method comprising:
identifying a query to perform in an emulated data analytics environment, the query comprising a plurality of operations;
parsing, by a first virtual machine (VM) executing a first operating system (OS), two subsets of operations from the plurality of operations, wherein a first subset of operations comprises operations to be performed within the first OS and wherein a second subset of operations comprises operations to be performed on a hardware accelerator;
sending, by the first VM, the second subset of operations to a custom interface;
receiving, by a second VM executing a second OS and from the custom interface, the second subset of operations;
executing, by the second VM, the second subset of operations using an emulated hardware accelerator executing on the second VM, wherein executing the second subset of operations comprises performing a read operation of a memory using a standard interface; and
returning, by the second VM, results associated with the second subset of operations to the first VM using the custom interface.

2. The computer-implemented method of claim 1, wherein the custom interface is a software agent configured to receive requests as a non-volatile memory express (NVMe) device and relay the requests to the second VM using an inter-VM channel.

3. The computer-implemented method of claim 2, wherein the inter-VM channel is a UNIX socket.

4. The computer-implemented method of claim 1, wherein the second OS is configured to emulate firmware executing on a hardware accelerator.

5. The computer-implemented method of claim 1, wherein the memory is a shared memory, the method comprising:
executing, by the first VM, the first subset of operations, wherein executing the first subset of operations comprises performing a read operation of the memory, using the custom interface.

6. The computer-implemented method of claim 5, wherein prior to identifying the query, the first VM writes a data file to the shared memory, and wherein executing the second subset of operations comprises performing a read operation of the data file.

7. The computer-implemented method of claim 1, wherein the standard interface is an NVMe host interface.

8. A non-transitory, computer-readable medium storing one or more instructions executable by a computer system to perform operations comprising:
identifying a query to perform in an emulated data analytics environment, the query comprising a plurality of operations;
parsing, by a first virtual machine (VM) executing a first operating system (OS), two subsets of operations from the plurality of operations, wherein a first subset of operations comprises operations to be performed within the first OS and wherein a second subset of operations comprises operations to be performed on a hardware accelerator;
sending, by the first VM, the second subset of operations to a custom interface;
receiving, by a second VM executing a second OS and from the custom interface, the second subset of operations;
executing, by the second VM, the second subset of operations using an emulated hardware accelerator executing on the second VM, wherein executing the second subset of operations comprises performing a read operation of a memory using a standard interface; and
returning, by the second VM, results associated with the second subset of operations to the first VM using the custom interface.

9. The computer-implemented method of claim 1, wherein the custom interface is a software agent configured to receive requests as a non-volatile memory express (NVMe) device and relay the requests to the second VM using an inter-VM channel.

10. The medium of claim 9, wherein the inter-VM channel is a UNIX socket.

11. The medium of claim 1, wherein the second OS is configured to emulate firmware executing on a hardware accelerator.

12. The medium of claim 1, wherein the memory is a shared memory, the operations comprising:
executing, by the first VM, the first subset of operations, wherein executing the first subset of operations comprises performing a read operation of the memory, using the custom interface.

13. The medium of claim 12, wherein prior to identifying the query, the first VM writes a data file to the shared memory, and wherein executing the second subset of operations comprises performing a read operation of the data file.

14. The medium of claim 1, wherein the standard interface is an NVMe host interface.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying a query to perform in an emulated data analytics environment, the query comprising a plurality of operations;
parsing, by a first virtual machine (VM) executing a first operating system (OS), two subsets of operations from the plurality of operations, wherein a first subset of operations comprises operations to be performed within the first OS and wherein a second subset of operations comprises operations to be performed on a hardware accelerator;
sending, by the first VM, the second subset of operations to a custom interface;
receiving, by a second VM executing a second OS and from the custom interface, the second subset of operations;
executing, by the second VM, the second subset of operations using an emulated hardware accelerator executing on the second VM, wherein executing the second subset of operations comprises performing a read operation of a memory using a standard interface; and
returning, by the second VM, results associated with the second subset of operations to the first VM using the custom interface.

16. The system of claim 15, wherein the custom interface is a software agent configured to receive requests as a non-volatile memory express (NVMe) device and relay the requests to the second VM using an inter-VM channel.

17. The system of claim 16, wherein the inter-VM channel is a UNIX socket.

18. The system of claim 15, wherein the second OS is configured to emulate firmware executing on a hardware accelerator.

19. The system of claim 15, wherein the memory is a shared memory, the operations comprising:
executing, by the first VM, the first subset of operations, wherein executing the first subset of operations comprises performing a read operation of the memory, using the custom interface.

20. The system of claim 19, wherein prior to identifying the query, the first VM writes a data file to the shared memory, and wherein executing the second subset of operations comprises performing a read operation of the data file.
